(19) United States
(12) Patent Application Publication
(10) Pub. No.: US 2024/0412656 A1
(43) Pub. Date: Dec. 12, 2024

(54) SYSTEM AND METHOD OF AUTOMATED AND ADAPTIVE TEST PREPARATION

(71) Applicants: Jennifer Owings, Staten Island, NY (US); Johannes Traa, Staten Island, NY (US); Jay Yogeshwar, Staten Island, NY (US)

(72) Inventors: Jennifer Owings, Staten Island, NY (US); Johannes Traa, Staten Island, NY (US); Jay Yogeshwar, Staten Island, NY (US)

(21) Appl. No.: 18/734,922

(22) Filed: Jun. 5, 2024

Related U.S. Application Data
(60) Provisional application No. 63/471,017, filed on Jun. 5, 2023.

(51) Int. Cl. G09B 7/06

(52) U.S. Cl. CPC G09B 7/06

(57) ABSTRACT

A computer program or system may be configured to provide automated, adaptive test preparation including adaptation based on test-taking anxieties and stresses exacerbated by learning gaps and providing comprehensive data analysis reports with next steps for users, guardians, and institutions.

### CROSS-REFERENCE TO RELATED APPLICATIONS

The present application claims priority to U.S. Provisional Application No. 63/471,017 filed Jun. 5, 2023, titled “SYSTEM AND METHOD OF AUTOMATED, ADAPTIVE TEST PREPARATION,” which is hereby incorporated by reference in its entirety.

### TECHNICAL FIELD

The embodiments generally relate to computer program products for test preparation, studying, and results analysis.

### BACKGROUND

Studying, and in particular, test preparation for standardized tests do not accommodate individual student needs including student stress or anxiety. Existing systems typically include video, tips, and strategies but do not account for real-time adaptive support to individual user needs. Existing test preparation materials also do not provide insight into regional standards and comprehensive data analysis with respect to both user success and institutional requirements.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for providing an automated and adaptive test preparation platform, including at least one user computing device in operable connection with a user network. An application server is in operable communication with the user network to host an application system for providing a test preparation interface and includes a user interface module for providing access to the test preparation interface environment through the user computing device. The user interface module displays one or more questions to the user to prompt the user to answer each of the one or more questions. A student model includes a motivation-stress module and a cognitive module. The motivation-stress module assesses the user's motivation-stress and assesses an affective and motivational state of the user to provide adaptive content, via a tutor model, based on test-taking anxieties and stresses exacerbated by learning gaps and providing comprehensive data analysis reports with progressive learning steps.

The disclosed computer program product generally relates to a system and method for automated, adaptive test preparation including application programs configured to provide equitable opportunities for students who may control their learning experience.

The disclosed computer program product generally relates to a system and method for automated, adaptive test preparation including adaptation based on test-taking anxieties and stresses exacerbated by pandemic learning gaps. Further, the system includes adaptation based on cognitive ability as determined by computation of relative skill level demonstrated by the user.

The disclosed computer program product generally relates to a system and method for automated, adaptive test preparation including providing comprehensive data analysis reports with next steps to users, guardians, and institutions.

In one aspect, the system includes one or more biometric sensors to analyze one or more biometric inputs.

In one aspect, the motivation-stress module is in operable communication with the one or more biometric sensors to determine one or more values associated with each of the one or more biometric inputs, and to attribute the one or more values with the affective and motivational state of the user.

In one aspect, the tutor model includes a prompt module and a learner response module.

In one aspect, the prompt module provides an adaptive prompt including the one or more questions.

In one aspect, the adaptive prompt includes dynamic question shaping and dynamic guidance to aid the user in answering the one or more questions.

In one aspect, the learner response module receives a user-input response to the one or more questions and determines if the user-input response is correct.

In one aspect, a feedback module generates feedback related to the user-input response.

In one aspect, a biometric analysis module establishes a plurality of baseline biometric values attributed to the user.

In one aspect, the biometric analysis module is capable of determining if the real-time biometrics received from the one or more biometric sensors indicate a change in the user's biometric status.

In some aspects, the motivation-stress module may adapt the scaffolding in conjunction with the user's cognitive capacity (i.e., their focus, output, etc.). Some problems may affect the user cognitively but not motivationally (and vice-versa). Combining these internal states allows for the system to adjust the content of is adaptive interactions to address cognition- or motivation-related scaffolding (or both) in a way that more effectively supports the learner.

In some aspects, the motivation-stress module may adapt and support effective test-taking habits related to the user's pace of problem-solving and suggest or otherwise implement breaks in the user's interaction with the test. Some users will not know to how to pace work on high-stress problems or know when to take mental breaks to manage overwhelm. The system may solicit feedback on the user's stress state at critical times to help build the user's test-taking self-awareness. This helps in developing more effective test preparation and test-taking habits through real-time interactions and feedback during high-potential periods of time (i.e., when the potential for the user to develop those habits is greatest).

In some aspects, the motivation-stress module may adapt based on the influence of social interactions within the application program. In such, the system may discern the effect of communication interactions on the user's stress/motivation. This enables the system to adjust the amount of community-related information that is relayed to the user. This is also discerned through actively soliciting feedback on the effect of this information on the user's motivation/stress. Some users may benefit from community interactions and others may find that community interactions detract from their learning. This allows users to better understand the effects and impact of such interactions.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the databases and application program, according to some embodiments;

FIG. 4 illustrates a flowchart of an adaptive learning flow implemented by the system, according to some embodiments;

FIG. 5 illustrates a screenshot of an exemplary question generated by the testing module, wherein the user is prompted with a verbal/reading comprehension multiple choice question, according to some embodiments;

FIG. 6 illustrates a screenshot of an exemplary question generated by the testing module, wherein hints and analysis are displayed, according to some embodiments;

FIG. 7 illustrates a flowchart of a decomposition process utilized by a prompt shaping module, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

The disclosed computer program product generally relates to a system and method for automated, adaptive test preparation including a systems for providing at least the following functionality.

As used herein, the term “user” may be used to describe a student, a teacher, an institution, a business providing learning material, or other individual or entity who is utilizing the system to learn or provide learning materials. It is to be understood that the term “user” may be used to refer to each user type collectively, or individually depending on context. While the primary focus of the disclosure provided herein describes a student or individual engaging in learning activities, the user may also be teachers or individuals/entities who are providing the learning material, assessing student progress and results, etc. In such, the system may be used to enable students/learners to efficiently learn concepts as well as be used by the teacher to assess teaching/instructional practices. The term “educator” may be used to refer to teachers, institutions, businesses, or others providing learning materials to the learner.

In general, the embodiments described herein relate to a system for providing an automated and adaptive test preparation platform. The system provides a dynamic test preparation platform which assesses the user's confidence, and specifically the user's confidence in regards to their academic learning and test taking to adaptively change the learning process. The system may utilize system-level interactions and interaction at the individual question level (i.e., macro and micro interactions) to assess various metrics associated with the user. Each interaction is recorded and analyzed such that information presented to the user is calibrated.

In some embodiments, the system may be operable to determine an “anxiety level” of the user. This may be determined by providing the user with a question, or series of questions which are presented to the user prior to the user engaging in a test-taking activity, learning activity, quiz, etc. Users may also be presented with a question or series of questions after they have completed a question, series of questions, a test, a quiz, a learning exercise, etc. which asks the user to input metrics related to their confidence, anxiety level, or other mental state. For example, following a set of questions, users may be asked to enter a level of difficulty they attribute to the series of questions (e.g., the system may prompt the user with a 1-5 scale, wherein 1 is less difficult and 5 is more difficult). A similar prompt may be presented to determine the user's anxiety levels following the series of questions (e.g., the system may prompt the user with a 1-5 scale, wherein 1 is less anxious and 5 is more anxious).

In some embodiments, the application program provides a means for an educator to access and utilize a plurality of student data to assess student metrics including student's progress. Further, the application program is capable of identifying features of the plurality of student metrics to improve instructional practices, and wherein the application program provides a means of comparing data sets across a population of students. Student metrics, as used herein, may be used to describe patterns, efficiencies, gaps in knowledge, opportunities for further progression in learning, answer accuracy, etc.

The system may provide users with a more engaged test preparation system via active test practice. The system may provide equitable opportunities to allow learner users to progress at their individual pace, using tools and functions provided by the system that the system terms are most applicable to the individual user needs. The system may provide immediate feedback based on the needs of individual users based on question success score in real time, or question success score overtime. The system may be configured to track time on each question or over a series of questions allowing a user to reflect on time spent on individual questions based on question category or the like. The system may be configured to allow users to determine which tools, tips, or strategies to use and when to use them when answering specific question types. The system may be configured to gradually, over time, reduce access to system tools, tips, and strategies to facilitate test taking success with reduced reliance on system assistance.

The system may be configured to populate questions specific to user needs or specific to progressively challenging a user in order to maximize independent question practice time. The system may be configured to provide immediate feedback on question answers and analysis to provide opportunities for user reflection on question answers and implementation of tools, tips, and strategies. Users may also access metrics regarding other users. For example, a teacher may access metrics related to their students (e.g., accuracy, challenging aspects, number of students currently logged on, etc.).

The system may be configured to provide comprehensive data report based on system usage, individual user's success growth, user strengths, user weaknesses, recommended next steps for increasing success, standards of mastery, effective time use, and the like.

The system may provide “tips” options allowing a user to seek real-time tips on how to solve questions such as providing hints towards correct questions answers.

The system may provide “strategies” options allowing a user to seek real-time strategies on how to solve questions prevented before the user.

The system may provide options to rephrase difficult practice questions.

The system may provide identification of key words or phrases relating to the answer to questions. For example, the system may allow users to curate a personalized list of challenging vocabulary or content terms.

The system may provide identification of “red herring” question elements unrelated to the answer to questions. Further, the system may provide explanations or analysis for “red herring” questions.

The system may provide tracking of time spent on questions to improve student question answering speed. The system may also identify user patterns or tendencies (i.e., the system may identify users who spend significantly more time on graphic questions in combination with commonly answering the graphic question incorrectly). This may provide an efficient means of identifying students who have difficulty with particular questions, subjects, question types, etc., thus providing an efficient means for a teacher to identify students who have problems with specific questions, subjects or question types.

The system may provide for the population of progressively challenging test preparation questions based on the cognitive module's tracking of the user success score as they progress through sample test questions.

The system may provide reading comprehension support by providing specific strategies for approaching various types of questions.

The system may provide question type grouping such as ratio, command of evidence, vocabulary, or the like, based on identified challenges appropriate for the user.

The system may provide question models with explanations to further facilitate identification of the correct answer to questions. In such, the system may provide users with challenges related to particular types of questions that are common to other users.

The system may provide dictionary functionality to provide definitions or provide examples of alternative terms, including populating a user-specific log or list of new terms for reference.

The system may provide extrapolated explanations of questions during simulated testing, rather than providing explanation after completion of an entire practice test. For example, the system may eliminate one or more answer options (such as the answer option used as a “distractor” or an irrelevant answer option) with explanations as to why these options are incorrect in order to provide users with fewer options that those which are originally presented.

The system may provide for automating feedback relating to test-taking anxiety, concerns, emotional stress, and the like about test timing, topic concerns, or the like. For example, the system may provide users with a “test anxiety” self-assessment prior to the user's interaction with the test.

This informs the system of when and how to provide support for addressing issues with the student's anxiety or confidence.

The system may provide user-specific reinforcement or encouragement, including confident-building strategies based on user progress, use of data, and the like.

The system may provide user support with respect to test taking “stamina” by populating progressively time-consuming individualized practice.

The system may provide users with growth monitoring data and individualized suggestions for next steps in individual test practice. In such, the system may provide options for users to connect and compare their growth metrics to other users (e.g., Students 1's growth on “Structure” questions: 56%; Student 1's average growth on “Structure” questions: 62%) along with tips for improving in specific question area. The system can measure users' growth in two distinct manners: relative to the individual user and relative to other users.

Measuring growth relative to individual users can be accomplished via conducting a comprehensive initial assessment to establish the user's baseline performance and to identify strengths and deficiencies across different skills or topics. Next, the system tailors the learning path based on initial assessment results and adjust the difficulty and content progressively to appropriately challenge the user. Further, the system may track performance at certain time intervals using metrics such as accuracy, time spent on each questions or question set, and improvement in specific area (i.e., subjects, question types, etc.). Lastly, the system provides feedback, reports, and steps which highlight progress, skill development, and provides the ability to curate more rigorous and/or adaptive material if needed.

When measuring growth relative to other users, the system may compare the user's initial baseline performance against a dataset of peer results (e.g., average scores, percentile ranks, etc.). The system may then implement statistical measure such as percentiles, standard deviations, and normalized scores to position the user relative to peers while also using the metrics to update the user's standing as they progress. Further, the system may create leaderboards or other rankings of users based on relative performance in various areas such that rankings are updated dynamically with each new component they have completed. Reports are provided showing how the user's performance ranks among their peers of the same caliber (i.e., their age, grade, education, etc.) and time spent using the system. This allows the system to highlight areas where the user excels and/or needs improvement relative to other users. The system may also provide periodic challenges, group tests, etc. to foster a competitive and collaborative spirit and environment. Results can be monitored and tracked to compare performances in the group setting. The system may also maintain a continuous feedback loop, including graphs, charts, and other visual aids in order to motivate and guide users based on their growth metrics and encourage reflective practices by allowing users to review their performance history.

The system may provide hyperlinks within questions to regional or national Common Core standards to allow instructors or institutional users to identify patterns or gaps within school instruction based on user ability or inability to efficiently answer questions correctly. Further, the system may provide comparative metrics, allowing educators and school administrators to compare their users' progress and mastery with users across the nation (or other users utilizing the system).

The system may provide comprehensive data with respect to time spent using the system, breakdowns of strengths or challenge areas, user test scores, mastery of standards, and the like to users, guardians, parents, and institutional subscribers.

In some embodiments, the system may be useful for aiding struggling learners (i.e., diagnosed or undiagnosed students with disabilities or Individual Education Programs (IEPs). To accomplish this, the system may provide a prompt asking users to input specific issues in order to provide data that will support the system in prioritizing targeted areas of need. In one example, the system may not directly ask if the user has a specific diagnosis (e.g., ADHD), but may ask users to respond to prompts using a scale of 1-5, wherein numbers 1-5 correspond to a mental state (e.g., confusion, difficulty, anxiety, etc.). For example, the system may prompt the user with: “Do you have difficulty focusing on longer passages? The user may then respond using numbers 1-5, wherein 1 is less difficult, and 5 is more difficult. One skilled in the arts will readily understand that the questions asked to the user may vary. In the above example, common ADHD-related questions may be asked.

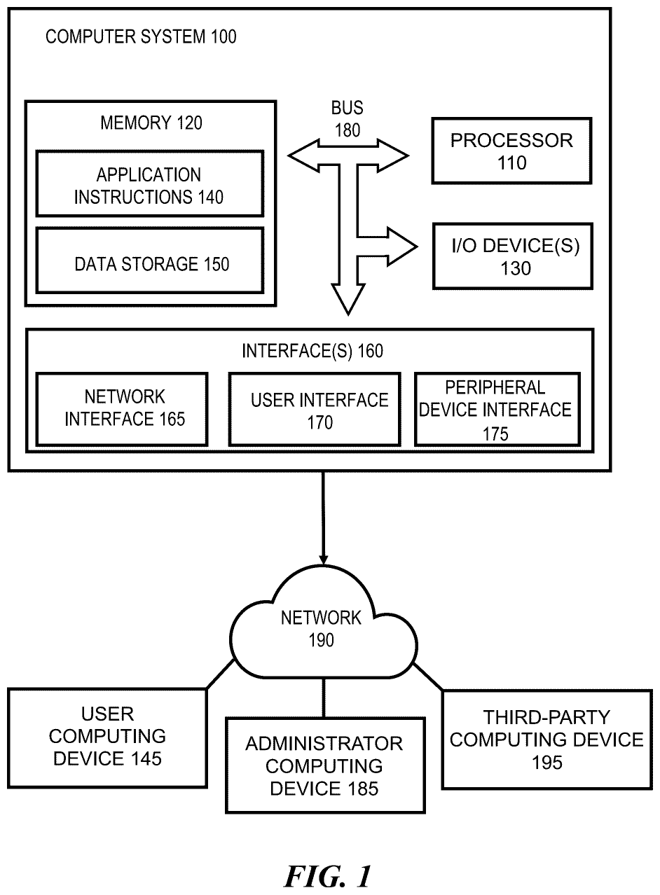

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

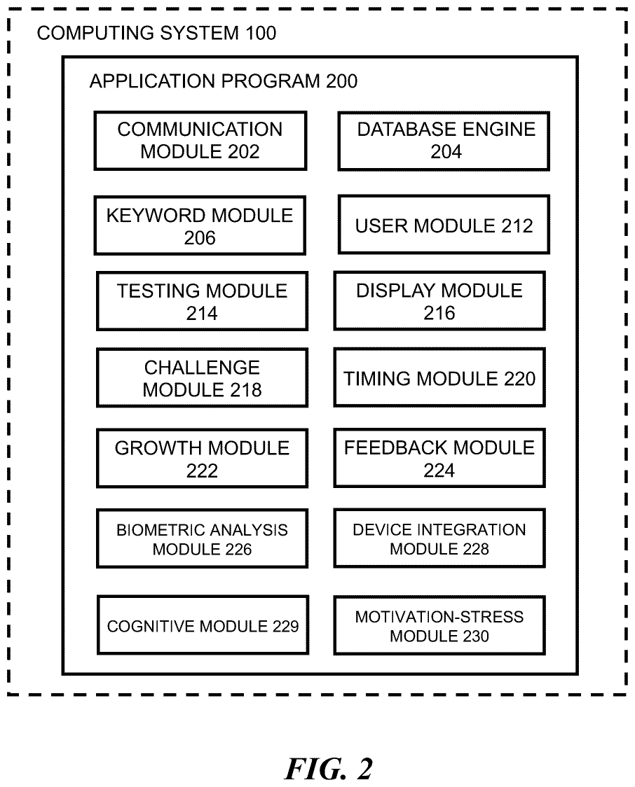

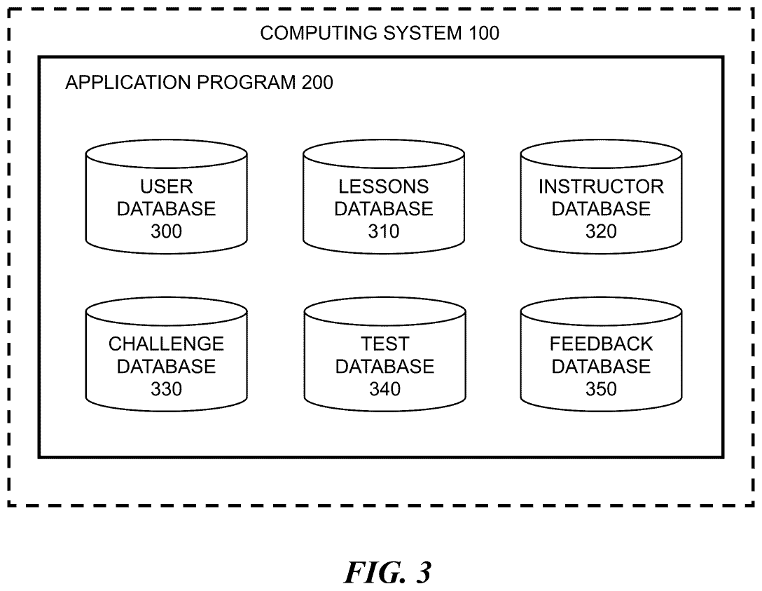

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases (see FIG. 3). In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a keyword module 206, a user module 212, a testing module 214, a display module 216, a challenge module 218, a timing module 220, a growth module 222, a feedback module 224, a biometric analysis module 226, a device integration module 228, a cognitive module 229, and a motivation-stress module 230.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the keyword module 206 is in operable communication with the application program to provide options to rephrase difficult practice questions; provide identification of key words or phrases relating to the answer to questions; and provide identification of “red herring” question elements unrelated to the answer to questions. The keyword module 206 may provide dictionary functionality to provide definitions or provide examples of alternative terms, including populating a user-specific log or list of new terms for reference.

In some embodiments, the user module 212 facilitates the creation of a user account for the application system. The user module 212 may allow the user to create a user profile which includes user information, preferences, and the like. The user module 212 may grant permissions to each user based on their user-type (i.e., a student, a teacher, or an administrator).

In some embodiments, the testing module 214 may be configured to provide for sequential or simultaneous mock questions to users, via a GUI, for text preparation. The testing module 214 may provide question models with explanations to further facilitate identification of the correct answer to questions. The testing module 214 may provide question type grouping such as ratio, command of evidence, vocabulary, or the like, based on identified challenges appropriate for the user. The testing module 214 may provide “tips” options allowing a user to seek real-time tips on how to solve questions such as providing hints towards correct questions answers; provide “strategies” options allowing a user to seek real-time strategies on how to solve questions prevented before the user.

In some embodiments, the testing module 214 may be adapted to support existing testing frameworks. For example, the testing module 214 may communicate with a third-party system to receive SAT test, GRE tests, MCAT tests, corporate training tests, DIY training materials, city/state tests, professional development tests, etc. The testing module 214 may receive information associated with studying for and taking tests provided by third parties. For example, the testing module 214 may receive and provide to user's study materials related to the MCAT test (or other tests).

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the challenge module 218 may be configured to populate progressively challenging test preparation questions based on tracked user success scores as they progress through sample test questions. The challenge module 218 may provide reading comprehension support.

In some embodiments, the timing module 220 is operable to provide user support with respect to test taking “stamina” by populating progressively time-consuming individualized practice. The timing module 220 may provide tracking of time spent on questions to improve student question answering speed.

In some embodiments, the growth module 222 may be configured to provide hyperlinks within questions to regional or national Common Core standards to allow instructor or institutional users to identify patterns or gaps within school instruction based on user ability or inability to efficiently answer questions correctly. The growth module 222 may provide comprehensive data with respect to time spent using the system, breakdowns of strengths or challenge areas, use your test scores, mastery of standards, and the like to users, guardians, parents, and institutional subscribers. The growth module 222 may provide users with growth monitoring data and individualized suggestions for next steps in individual test practice.

During use of the system, users are prompted to take a baseline assessment sans any technological supports or strategies. Initial baseline assessment data is stored by the system to determine growth metrics. Growth metrics are determined to reflect growth and/or mastery of each skill on an internal scale of 0 (lowest/nonexistent) to 10 (highest/perfect) and measured at various junctures. Growth metrics will be utilized by the system to generate prompts, suggestions, feedback, strategic questions, and next steps/suggestions for users. Growth metrics may only be shared with users to indicate milestones as measures of reinforcement (such as informing users they reached a new milestone of 50% growth, 75% growth, etc. on a specific skill, standard, or type of question).

In some embodiments, the feedback module 224 may be configured to provide extrapolated explanation of questions during simulated testing, rather than providing explanation after completion of an entire practice test. The feedback module 224 may provide for automating feedback relating to test-taking anxiety, concerns, emotional stress, and the like about test timing, topic concerns, or the like. The feedback module 224 may provide user-specific reinforcement or encouragement, including confident-building strategies based on user progress, use of data, and the like.

In some embodiments, the biometric analysis module 226 may be in communication with a device integration module 228 to analyze biometric information captured by biometric sensors, a camera, or similar devices. The biometric analysis module 226 may determine the presence or absence of various biometric indicators which can be used to determine if the user is stressed, anxious, calm, nervous, distracted, focused, etc. This information may be used to provide feedback, via the feedback module 224, which can alert the user to their current biometric status and suggest mitigation techniques. In another embodiment, the biometric analysis module 226 may transmit inferred biometric statuses the various other modules to adjust test question difficulty, alter learning techniques, etc.

In some embodiments, biometric analysis of the user may be an optional feature of the system. This may be especially useful as biometric analysis of users who are minors may be seen as controversial or unwanted in some instances.

In some embodiments, the device integration module 228 may be operable to connect to and communicate with various devices which can be used as a component of the learning process, or as a component of the biometric analysis process described herein. For example, device may include smartwatches, cameras, microphones, computer I/O devices (i.e., a mouse), smartphones, AR/VR glasses/goggles, tablets, etc.

In some embodiments, the cognitive module 229 is in communication with the application program to determine the relative skills level of the user. In one example, skills are broken into mathematical, verbal and analytical skills. Skill level may be determined based on a set of calibration questions that goes from simple to hard on a 0 through 10 scale, a continuous rational number. Skill rating or level may be a dynamically varying quantity, measured at every available opportunity. When a user starts participating in test taking or similar assessments, they are usually assigned an initial rating based on their performance. This initial rating may vary depending on factors such as previous performance, previous certificates, or based on a set of calibration questions administered to the user. In each rated test taking, a user's performance is compared to their expected performance based on their rating and the ratings of the questions (or ratings of other learners in a multi learner social learning environment). If a user performs better than expected, their rating will increase; if they perform worse, it will decrease. Correctly answering a higher-rated question typically results in a larger rating increase than correctly answering a lower-rated question. Conversely, incorrectly answering a lower-rated question usually results in a larger rating decrease than incorrectly answering a higher-rated question. We may impose a minimum rating (floor) and a maximum rating (ceiling) for learners. This prevents a user's rating from dropping too low or rising too high beyond certain thresholds. In summary, the rating system provides a means to measure and compare the relative strengths of users in the system.

In some embodiments, the cognitive module 229 is configured to assess the relative strengths of the user, and use this information to adapt to the amount, type, and timing of scaffolding provided. When the system notices that the user has a lower skill rating to address a problem (i.e., the user finds the question more challenging), it provides more scaffolding for the problem, while engaging the user with additional prompt shaping to guide them towards an answer.

In some embodiments, a motivation-stress module 230 is in communication with the application program to determine a state of the user. In one example, the motivation-stress module 230 may operate by soliciting feedback from the user via a plurality of questions or prompts which are provided to the user. The questions may be input via the I/O devices of the computing system such as by inputting text, or through the use of spoken responses (e.g., through the use of a microphone and speaker). Questions, for example, may be similar to “How difficult do you perceive the question to be?” “What aspects of a problem feel most challenging?” “How much additional help or practice would you like on certain skills or types of questions?” “Do you feel as though you are making sufficient progress towards your goals?”.

The motivation-stress module 230 may transmit the above questions or a single questions between problem sets (lessons) as a multi-question survey. It may also embed the questions or a single questions within each lesson as questions designed to target maximally information aspects of the students' learning. In another example, the application may utilize spoken language interactions to enable the user to prompt the system.

The motivation-stress module 230 is configured to monitor the user's motivation- and stress-related metrics and adapt to the amount, type, and timing of scaffolding provided. When the system notices that the user has a lower capacity than usual (i.e., the user is more stressed or less motivated), it provides more scaffolding for the problems that the user tends to find demotivating (i.e., higher risk from a motivational standpoint). It may also solicit additional feedback related to stress and motivation around these problems to gauge shifts in these mental states in order to adjust the scaffolding in real-time.

In some embodiments, the motivation-stress module 230 may adapt the scaffolding in conjunction with the user's cognitive capacity (i.e., their focus, output, etc.). Some problems may affect the user cognitively but not motivationally (and vice-versa). Combining these internal states allows for the system to adjust the content of is adaptive interactions to address cognition- or motivation-related scaffolding (or both) in a way that more effectively supports the learner.

In some embodiments, the motivation-stress module 230 may adapt and support effective test-taking habits related to the user's pace of problem-solving and suggest or otherwise implement breaks in the user's interaction with the test. Some users will not know to how to pace work on high-stress problems or know when to take mental breaks to manage overwhelm. The system may solicit feedback on the user's stress state at critical times to help build the user's test-taking self-awareness. This helps in developing more effective test preparation and test-taking habits through real-time interactions and feedback during high-potential periods of time (i.e., when the potential for the user to develop those habits is greatest).

In some embodiments, the motivation-stress module 230 may adapt based on the influence of social interactions within the application program. In such, the system may discern the effect of communication interactions on the user's stress/motivation. This enables the system to adjust the amount of community-related information that is relayed to the user. This is also discerned through actively soliciting feedback on the effect of this information on the user's motivation/stress. Some users may benefit from community interactions and others may find that community interactions detract from their learning. This allows users to better understand the effects and impact of such interactions.

In some embodiments, strategic feedback interfaces are utilized to provide appropriate and supportive feedback placed at or near high-risk problems to enhance the student's learning by adapting to their motivational and stress-related needs. In order to provide adaptable information, the system may receive information from various sources including passive observations (e.g., time taken on specific problems or problem sets, number of hints needed, patterns of mouse clicks or screen touches, etc.) and active interaction with the user through solicited feedback as described above.

In some embodiments, the system may utilize multi-time horizon tracking of user states. In such, the system will maintain an internal state of the suer's motivational and stress states over two time horizons (i.e., short term and long term). Meanwhile the user may experience session-to-session variations in motivation and stress. Once the system understands these patterns, it can deploy adaptations in presenting problems, associated scaffolding, and feedback interactions that enhance the student's learning.

In some embodiments, the system provides the ability to utilize both passive and direct observations of the user to adapt feedback interactions. This mimics an empowering interaction with a tutor/coach in which the latter gathers information through reflective listening and targeted questions.

The system makes direct interactions with the user maximally relevant through the system's adaptation to the user's short- and long-term learning needs. This aids in avoiding “survey fatigue” which can be caused by the user's inability to perceive substantive change relative to the effort exerted in answering questions. This is exacerbated if the questions are not relevant to the user's needs, thus being a detriment to motivation, rather than an enhancement to motivation.

FIG. 3 illustrates a block diagram of the databases and application program 200. A user database 300 stores user information including personal information, contact information, user results (i.e., test and challenge results), user preferences, user tendencies (i.e., known stressors), user biometric information, etc. A lessons database 310 is operable to store lesson information which is utilized throughout the learning process. An instructor database 320 stores instructor information which can be used to identify and verify the identity of the instructor, store lesson plans, tests, challenges, etc. which are associated with the instructor. A challenge database 330 stores test preparation questions based on tracked user success score as they progress through sample test questions. A test module 340 stores test information and test questions which can be transmitted to the user. A feedback database 350 stores feedback which can be transmitted as-needed throughout the learning, testing, and challenge processes.

In some embodiments, A RAG-AI database (or similar database) stores the corpus of reference material which is pertinent to each test. This material provides the ground truth for many elements of the adaptive learning process including hints, definitions, summarization, background context, and answers to prompts from the user.

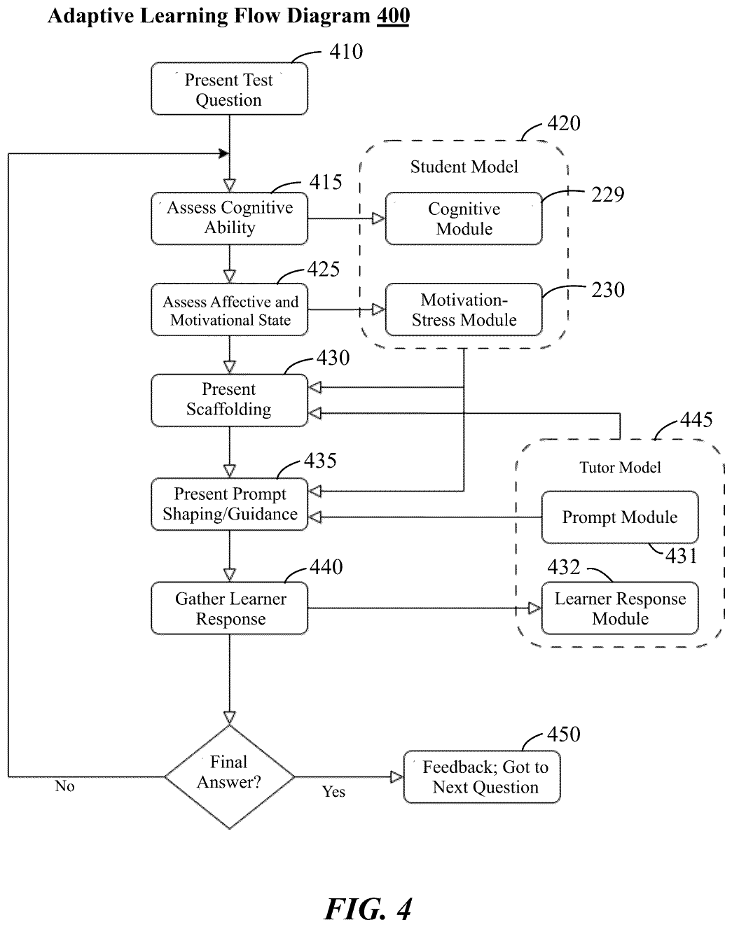

FIG. 4 illustrates an adaptive learning flow diagram 400 which illustrates an exemplary process implemented by the computer system. In block 410, a test question is presented and in block 415 the user's cognitive ability is assessed using the cognitive module 229. A student model (block 420) includes the cognitive module 229 and the motivation-stress module 230. In block 425, the user's affective and motivational state are assessed via the motivation-stress module 230. In block 430, the learning scaffolding is presented, and a prompt is presented, via prompt module 431, including shaping/guidance elements in block 435. The user may then input a response to the prompt in block 440 which is transmitted to the learner response module 432. The tutor model (block 445) includes the prompt module 431 and learner response module 432. Once a final answer is input, the system provides feedback in block 450. This process may be repeated if a final answer is not yet confirmed by the user, or if additional assessment is necessary.

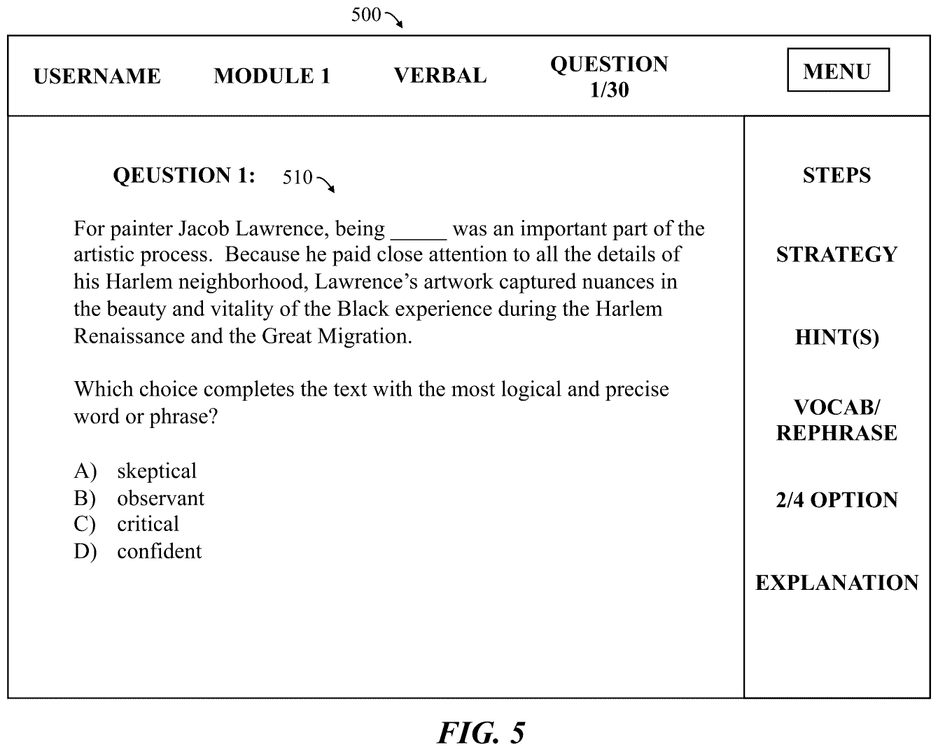

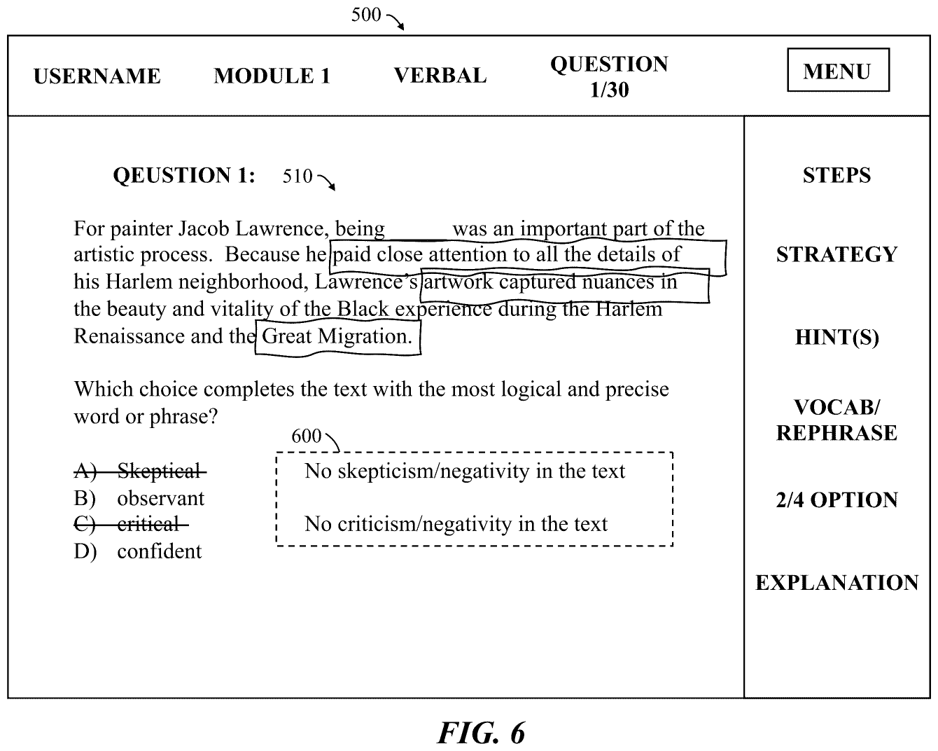

FIG. 5 and FIG. 6 illustrate exemplary screenshots of the user interface 500 which includes a prompt 510 for a question provided as an element of an examination, challenge, or quiz. The user interface 500 may display steps for answering or otherwise working through each particular question. The user interface 500 may also display strategies or hints which can be selectively displayed (via user input) which aids the user in answering the question correctly using dynamic techniques. The user interface 500 may also display an explanation of each element of the strategy, steps, and rationale for the correct answer. FIG. 6 illustrates an analysis pop-up 600 which displays analysis of the questions and an explanation for the rationale behind the correct answer. The analysis pop-up 600 may also be used to display rationale and explanations for why certain answers are incorrect. In such, this allows the user to deduce the correct answer using step-by-step rationale provided by the system.

In some embodiments, macro-level interactions include assessing the users cognitive and psychological states. This information is then used during micro-level interactions to dynamically guide the subject through an optimal learning process.

In some embodiments, the exemplary process for learning consists of a series of interactions leading to the selection of the final choice for the test question under consideration. While the ‘next step’ in the learning process consists of revealing new clues to the question, there may also be a retrograde step, pulling back to a higher level and clarifying basic understanding. The next step is also based on prompt shaping or getting the subject to ask a series of logical questions creating a chain of thought. In other words, the system guides the subject on creating a series of prompts. Prompt shaping modules may be scaffolded in order to provide more support with earlier use or with questions/topics users find more challenging. In such, as the user progresses through their own learning process, less prompt shaping may be provided, and the scaffolding is removed as users master how to approach and answer questions. This provides a dynamic system which provides scaffolding and prompt shaping as-needed which may be modified depending on the user's confidence, anxiety, and ability to answer questions.

In some instances, it is possible that the student has no prior knowledge of the subject under question, has partial knowledge or quite possibly incorrect knowledge. Prompt shaping is a way to elicit from the student what he/she does or does not know. A problem may be broken down into three parts: background knowledge, working knowledge, and drawing conclusions. Students are provided support and feedback at each step of this process application of knowledge to a sequence of steps for problem solution, and a final conclusion or inference resulting in the answer choice.

The student may explicitly ask for an explanation, or the right explanation may be offered based on an intermediate response. Retrieval-augmented generation, a popular AI technique is used to then provide the necessary explanation.

Students may also seek to reactivate support applications at any juncture after they have opted to remove them. In short, students who have previously removed scaffolding tips and strategies may opt to redeploy them on an as-needed basis.

In some embodiments, users have two options for attempting more complex aspects of a topic or seeking to move onto another topic: First, upon answering a specified number of questions pertaining to a topic accurately, they will be prompted to move onto a new topic or prompted with more complex problems pertaining to the same topic. Second, users can decide for themselves when to scale back on using scaffolding tips and prompts and/or opt to move onto a new topic or more complex problem independently. Provided their initiatives are successful, the system will retain this data in order to prompt future independent initiatives to progress to new topics. Provided users' initiatives are unsuccessful, the system will allow users to reactivate prior support prompts.

In some embodiments, the system utilizes a cognitive module to keep track of skill levels and prompt shaping modules to break down larger concepts into smaller questions. For example, users approaching a vocabulary in context question will be provided the question exactly as it would appear on the actual test. Users may opt to enable a series of prompts to activate various supports, such as: rephrasing, providing steps to approaching multi-step problems, highlighting clues, identifying ‘distractor’ options, prompting explanations for incorrect options, etc.

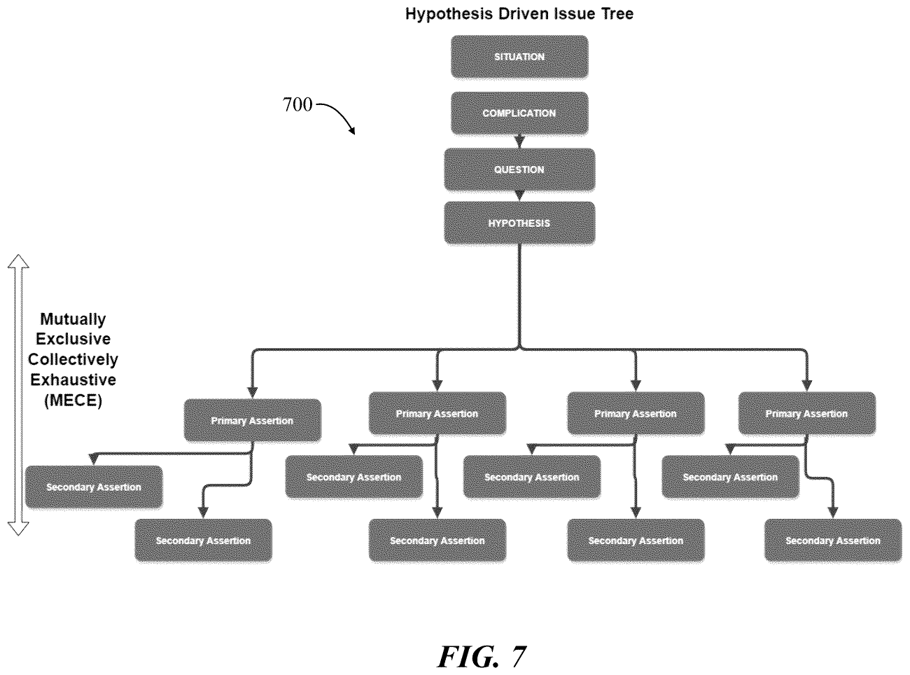

FIG. 7 illustrates a flowchart of a decomposition process utilized by a prompt shaping module 700. The prompt shaping module 700 is provided to aid learners in generating a set of series of prompts that may guide them to the desired answer (i.e., the correct answer for a question). The prompts may represent a “chain of reasoning” methodology to facilitate the user's determination of the correct answer to a question. The prompt guidance provided by the system facilitates the identification of a question to ask the system and helps shape the user's strategy for asking questions which are productive in leading them to the correct answer. The prompt shaping module may be in operable communication with an AI engine capable of guiding the learner throughout their learning process. The AI engine may receive user prompts and adapt its outputs based on user input, test results, user anxiety/confidence, etc.

In some embodiments, the prompt shaping module 700 may be guided by various principles including the Barbara Minto Pyramid and Issue Tree Decomposition. The Barbara Minto Pyramid communication principle helps organize information in a structured, hierarchical way to facilitate clear and effective communication. The Issue tree decomposition based on the above principle, helps to break down a problem as a solution hypothesis which may be corroborated by a set of underlying questions organized hierarchically. These questions at each level are mutually exclusive, but collectively exhaustive.

In one example, the techniques described above can be used by first deriving a hypothesis using the following consideration: the “situation”, the “complication”, and the “question”. The situation provides a narrative of the context of the learner (i.e., what the system known about the learner, including subject matter for the particular questions being provided to the learning). The complication factors the limitations, weaknesses, and/or particular skills of the learner. The question pertains to the solution approach to the specific test question under consideration. To form the hypothesis, the system may entice the learner to ask a set of questions that forms a chain of reasoning to solve the problem. This allows for questions to be presented which breaks up a problem into mutually exclusive and collectively exhaustive categories. Each question in turn is composed of additional questions at a level below that, wherein each level is a summary of all levels below it.

For example, a “level 1 question” may be: Do you know the question category? For example: geometry, statistics, algebra, etc. Do you know the underlying identities, theorems, axioms? Do you know the knowns and unknowns: What relevant facts are given or shared and what is missing? Or Do you know the underlying skill set required to solve? Equation solving; filling a pattern, numeric calculations from a formula, etc.?

A “level 2 question” (or subsequent level question(s)) may delve deeper into level 1 with questions such as what?, why?, or how? These aspects are provided to obtain details associated with the primary assertion. In one example, questions may take the form: What tools or techniques may be employed to approach the solutions? For example, “What trigonometric identities are useful in the context of this problem? What unit measure apply to this problem, and what is their definition? The “why?” aspect raises questions about the validity of a solution. For instance, why is approach 1 better than approach 2? Etc. Similarly, the “how?”, “when?” or “where” questions help to peel or strip away additional layers of complexity to obtain clarity for the proposed solution.

The prompt shaping module will dynamically create the issue tree decomposition for each problem and use the questions beginning at Level 1 to elicit the prompts from the subject. These prompts are fed to RAG-AI (Retrieval Augmented Generation AI model) that create the scaffolding and hints for the learner.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. A system for providing an automated and adaptive test preparation platform, the system comprising:
at least one user computing device in operable connection with a user network;
an application server in operable communication with the user network, the application server configured to host an application system for providing a test preparation interface, the application system having a user interface module for providing access to the test preparation interface environment through the user computing device, wherein the user interface module displays one or more questions to the user to prompt the user to answer each of the one or more questions; and
a student model includes a motivation-stress module and a cognitive module, the motivation-stress module to assess the user's motivation-stress, the cognitive module to assess a relative skills level of the user to provide adaptive content, via a tutor model, based on test-taking anxieties and stresses exacerbated by learning gaps and providing comprehensive data analysis reports with progressive learning steps.

2. The system of claim 1, further comprising one or more biometric sensors to analyze one or more biometric inputs.

3. The system of claim 2, wherein the motivation-stress module is in operable communication with the one or more biometric sensors to determine one or more values associated with each of the one or more biometric inputs, and to attribute the one or more values with the affective and motivational state of the user.

4. The system of claim 1, wherein the tutor model includes a prompt module and a learner response module.

5. The system of claim 4, wherein the prompt module provides an adaptive prompt including the one or more questions.

6. The system of claim 5, wherein the adaptive prompt includes dynamic question shaping and dynamic guidance to aid the user in answering the one or more questions.

7. The system of claim 4, wherein the learner response module receives a user-input response to the one or more questions and determines if the user-input response is correct.

8. The system of claim 7, further comprising a feedback module to generate feedback related to the user-input response.

9. The system of claim 1, further comprising a biometric analysis module to establish a plurality of baseline biometric values attributed to the user.

10. The system of claim 9, wherein the biometric analysis module is capable of determining if the real-time biometrics received from the one or more biometric sensors indicate a change in the user's biometric status.

11. A system for providing an automated and adaptive test preparation platform, the system comprising:
at least one user computing device in operable connection with a user network;
an application server in operable communication with the user network, the application server configured to host an application system for providing a test preparation interface, the application system having a user interface module for providing access to the test preparation interface environment through the user computing device, wherein the user interface module displays one or more questions to the user to prompt the user to answer each of the one or more questions;
a student model includes a motivation-stress module and a cognitive module, the motivation-stress module to assess the user's motivation-stress and to assess an affective motivational state, the cognitive module to assess a relative skills level, wherein the motivation-stress module and the cognitive module provide adaptive content, via a tutor model;
a prompt module to provide an adaptive prompt including the one or more questions; and
a learner response module to receive at least one user-input answer and to determine if the user-input answer is correct; and
a feedback module to generate dynamic feedback corresponding to the user-input answer and to display the dynamic feedback on the user interface,
wherein the application program provides a means for an educator to access and utilize a plurality of student data to assess student metrics including student's progress, wherein the application program is capable of identifying features of the plurality of student metrics to improve instructional practices, and wherein the application program provides a means of comparing data sets across a population of students.

12. The system of claim 11, further comprising one or more biometric sensors to analyze one or more biometric inputs.

13. The system of claim 12, wherein the motivation-stress module is in operable communication with the one or more biometric sensors to determine one or more values associated with each of the one or more biometric inputs, and to attribute the one or more values with the affective and motivational state of the user.

14. The system of claim 13, wherein the adaptive prompt includes dynamic question shaping and dynamic guidance to aid the user in answering the one or more questions.

15. The system of claim 14, wherein the learner response module receives a user-input response to the one or more questions and determines if the user-input response is correct.

16. The system of claim 15, further comprising a feedback module to generate feedback related to the user-input response.

17. The system of claim 1, further comprising a biometric analysis module to establish a plurality of baseline biometric values attributed to the user.

18. The system of claim 9, wherein the biometric analysis module is capable of determining if the real-time biometrics received from the one or more biometric sensors indicate a change in the user's biometric status.

19. A method for providing an automated and adaptive test preparation platform, the system comprising:
presenting a prompt to a user, the prompt including at least one questions;
assessing, via a motivation-stress module, the motivation-stress of the user;
assessing, via a cognitive module, a relative skill level of the user;
receiving, via an motivation-stress module, one or more biometrics from one or more biometric sensors, the biometrics to determine an affective and motivational state of the user;
presenting, via a tutor model, a scaffolding related to the prompt to display guidance related to the prompt; and
receiving, via a learner response module, a response to each of the at least one questions and displaying, via a feedback module, feedback related to the response.

20. The method of claim 19, wherein the application program provides a means for an educator to access and utilize a plurality of student data to assess student metrics including student's progress, wherein the application program is capable of identifying features of the plurality of student metrics to improve instructional practices, and wherein the application program provides a means of comparing data sets across a population of students.
